(19) United States
(12) Patent Application Publication
(10) Pub. No.: US 2026/0188959 A1
(43) Pub. Date: Jul. 2, 2026

(54) BLOCK AND CONTACT BLOCK

(71) Applicants: FANUC CORPORATION, Yamanashi (JP); WEIDMUELLER INTERFACE GMBH & CO. KG, Detmold (DE)

(72) Inventors: Masahiro SAEKI, Yamanashi-ken (JP); Shinichi KUWAHATA, Yamanashi-ken (JP); Jens OESTERHAUS, Detmold (DE); Jan MEIER, Detmold (DE); Ralf SCHUMACHER, Lemgo (DE); Klaus PUESCHNER, Detmold (DE); Torsten DIEKMANN, Leopoldshoehe (DE)

(21) Appl. No.: 18/858,694

(22) PCT Filed: Apr. 28, 2022
(86) PCT No.: PCT/JP2022/019307

§ 371 Date: Oct. 21, 2024

(51) Int. Cl. H01R 31/06; H01R 12/70; H01R 13/05

(52) U.S. Cl. CPC H01R 31/06; H01R 12/7082; H01R 13/057

(57) ABSTRACT

A block having two contactors adjacent to each other in a prescribed installation direction, the two contactors having approximate inverted U-shapes that are open in an insertion direction orthogonal to the prescribed installation direction, the block including a support member for supporting the two contactors, and the support member being provided with a slit for inserting a circuit board between the two contactors along the insertion direction, and a first wall portion for restricting displacement of a contact point of the two contactors in the prescribed installation direction.

### TECHNICAL FIELD

The present invention relates to a contact block in which a plurality of contactors are installed, and a block provided in the contact block.

### BACKGROUND ART

JP 2018-056503 A discloses an I/O unit. According to JP 2018-056503 A, a plurality of I/O units are installed on a DIN rail.

### SUMMARY OF THE INVENTION

The I/O unit includes a plurality of contactors. The plurality of contactors are terminal groups provided on both sides of the I/O unit (see also JP 2018-056503 A). Two I/O units adjacent to each other on the DIN rail are electrically connected to each other by bringing the plurality of contactors of the two I/O units into contact with each other.

The I/O unit further includes an electric circuit that performs processing for transmitting and receiving signals to and from another I/O unit. The electric circuit is formed on a board, for example. The circuit board (a board on which an electric circuit is formed) is inserted between the plurality of contactors arranged on one side of the I/O unit and the plurality of contactors arranged on the other side of the I/O unit.

Here, the contactor may interfere with the circuit board to be inserted. Further, the contactor that interferes with the circuit board may be subjected to buckling by the influence of the pressure applied from the circuit board.

The present invention has the object of solving the aforementioned problem.

A first aspect of the present invention is characterized by a block including: two contactors which are arranged adjacent to each other along a predetermined installation direction to be electrically connected to each other; and a support member configured to support the two contactors so as to be arranged along the predetermined installation direction, wherein the support member is provided with a slit configured to allow a detachable circuit board to be inserted between the two contactors along an insertion direction that is orthogonal to the predetermined installation direction, in order to electrically connect the detachable circuit board and the two contactors, the two contactors have a substantially U-shape that opens toward a direction opposite to the insertion direction when viewed from a direction orthogonal to the predetermined installation direction and the insertion direction, and a first wall portion is provided on the support member, the first wall portion being configured to prevent a contact point between the two contactors from being dislocated in the predetermined installation direction.

A second aspect of the present invention is characterized by a contact block into which a circuit board is inserted, the contact block and another contact block being arranged adjacent to each other along a predetermined installation direction to be electrically connected to each other, the contact block including: a plurality of the blocks according to the first aspect, wherein the plurality of blocks are stacked in a direction orthogonal to the predetermined installation direction and the insertion direction in a manner so that the slit of each of the plurality of blocks communicates with the slit of another of the plurality of blocks.

According to the present invention, it is possible to reduce the risk of buckling of the contactor.

### BRIEF DESCRIPTION OF DRAWINGS

FIG. 1A is a perspective view of an I/O unit according to a reference example; FIG. 1B is an exploded view of the I/O unit of FIG. 1A;

FIG. 2 is a perspective view showing a contact block according to a reference example;

FIG. 3A is an end view taken along line IIIA-IIIA of FIG. 2; FIG. 3B is a view showing the contact block of FIG. 3A with a circuit board inserted therein;

FIG. 4 is a view showing three contact blocks arranged in a left-right direction in the same sectional view as that of FIG. 3A;

FIG. 5 is a view showing a contact block according to an embodiment; and

FIG. 6 is a top view of a block according to the embodiment.

### DETAILED DESCRIPTION OF THE INVENTION

### Embodiments

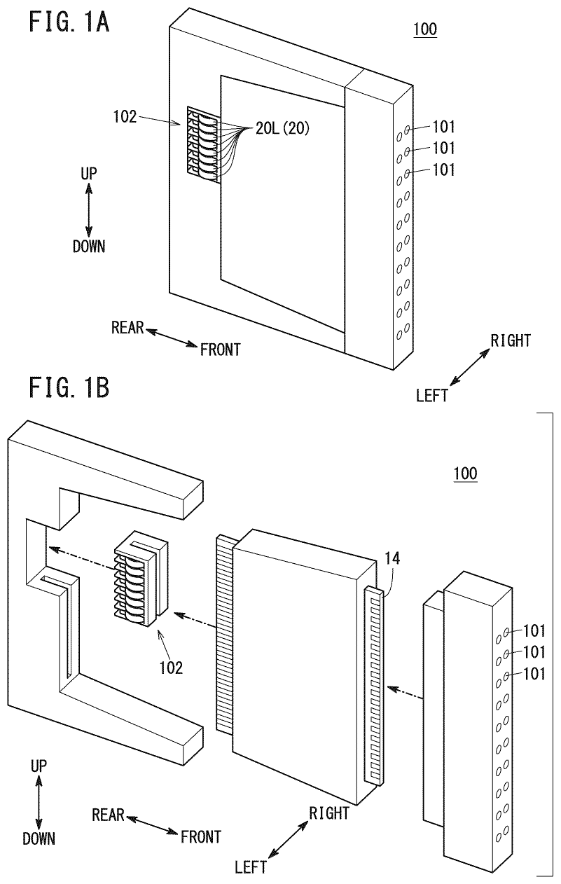

FIG. 1A is a perspective view of an I/O unit 100 according to a reference example. FIG. 1B is an exploded view of the I/O unit 100 of FIG. 1A. The right side portion of the I/O unit 100, which is not shown in FIG. 1A, is substantially symmetrical to the left side portion of the I/O unit 100.

A plurality of arrows shown in each drawing indicate directions (front, rear, left, right, up, and down) used in the following description. The front-rear direction, the left-right direction, and the up-down direction are orthogonal to each other. The front-rear direction and the left-right direction are parallel to a horizontal plane, for example.

The I/O unit 100 is an electronic device that inputs and outputs signals between a control device and a device. The control device is, for example, a numerical control device that controls a machine tool. The device is, for example, an actuator, a detector, or the like provided in the machine tool.

The I/O unit 100 includes a circuit board 14, a plurality of insertion-receiving portions 101, and a contact block 102.

The circuit board 14 is a board on which an electric circuit for performing processing necessary for inputting and outputting signals between the control device and the devices is formed. The electric circuit includes, for example, a control integrated circuit (IC).

The insertion-receiving portion 101 is provided, for example, in a front portion of the I/O unit 100. A terminal of a device is inserted into the insertion-receiving portion 101. Thus, the I/O unit 100 and the device are connected to each other via the insertion-receiving portion 101. The I/O unit 100 includes a plurality of insertion-receiving portions 101. Therefore, a plurality of devices can be connected to one I/O unit 100. The device connected to the I/O unit 100 is connected to the circuit board 14 of the I/O unit 100.

The contact block 102 is provided to connect the circuit board 14 of the I/O unit 100 to another I/O unit 100 installed next to the I/O unit 100.

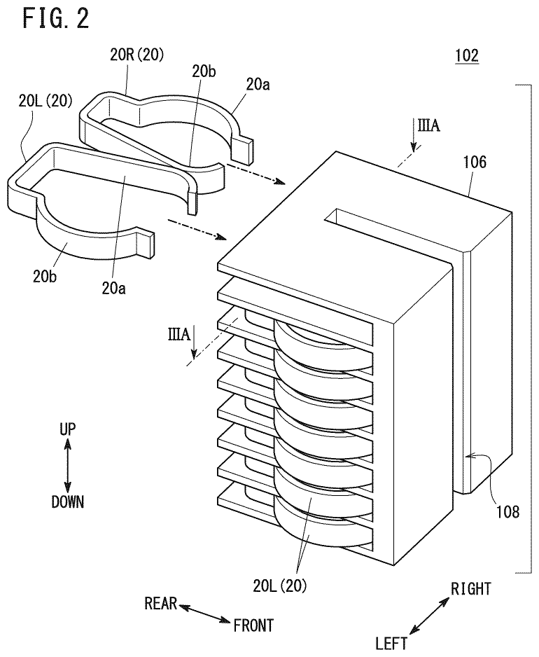

FIG. 2 is a perspective view showing a contact block 102 according to a reference example.

The contact block 102 includes a plurality of contactors 20 and a support member 106.

The support member 106 is an insulating member that supports the plurality of contactors 20. The material for the support member 106 includes, for example, an insulating resin. The support member 106 has an insertion opening 108.

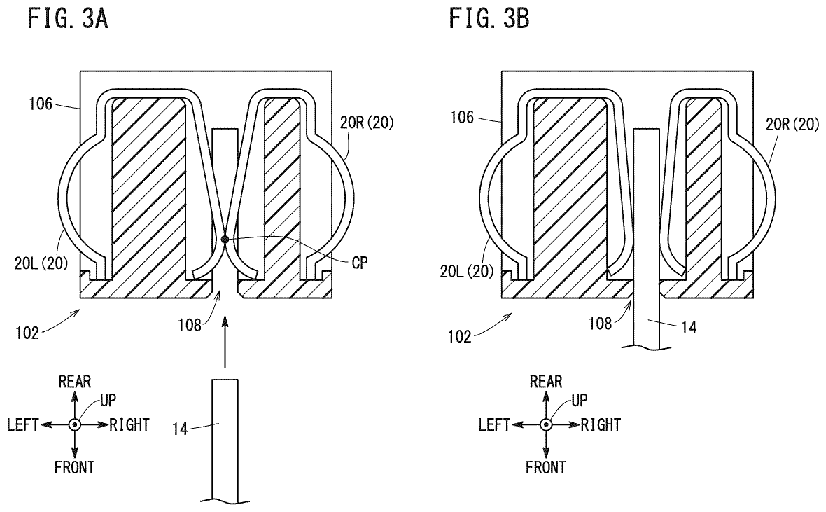

The insertion opening 108 is formed in the support member 106 at a substantially center in the left-right direction. The insertion opening 108 is an opening into which the circuit board 14 is inserted (see FIG. 3A and FIG. 3B). The circuit board 14 is inserted into the insertion opening 108 from the front side of the insertion opening 108 toward the rear side.

Each of the plurality of contactors 20 is an electrically conductive member having a substantially U shape. The material for the plurality of contactors 20 includes, for example, a metal. Each contactor 20 has a right end 20a and a left end 20b in the left-right direction.

The plurality of contactors 20 (20L, 20R) include a plurality of contactors 20L and a plurality of contactors 20R. The plurality of contactors 20L and the plurality of contactors 20R are arranged so as to interpose the insertion opening 108 in the left-right direction.

Each of the contactors 20L is a contactor 20 for connecting the circuit board 14 to an electronic device installed on the left side of the I/O unit 100. The plurality of contactors 20L are arranged in the up-down direction. At least a part of each contactor 20L is exposed to the outside at the left side of the I/O unit 100 (see also FIG. 1A).

Each of the plurality of contactors 20R is a contactor 20 for connecting the circuit board 14 to an electronic device installed on the right side of the I/O unit 100. The plurality of contactors 20R are arranged in the up-down direction. At least a part of each contactor 20R is exposed to the outside at the right side of the I/O unit 100. At least a part of each contactor 20R is exposed to the outside, for example, substantially symmetrically with the contactor 20L.

FIG. 3A is an end view taken along line IIIA-IIIA of FIG. 2.

The contactor 20 is attached to the support member 106 along the front direction from the rear of the support member 106. In this regard, the rear of the support member 106 is open to allow the contactor 20 to be mounted.

Among the plurality of contactors 20 attached to the support member 106, the contactor 20L and the contactor 20R that are disposed at substantially the same position in the up-down direction may be in contact with each other. The contact point CP shown in FIG. 3A indicates a contact point between the contactor 20L and the contactor 20R which are disposed at substantially the same position in the up-down direction. The contact point CP is located at substantially the center of the insertion opening 108 in the left-right direction.

FIG. 3B is a view of the contact block 102 of FIG. 3A with the circuit board 14 being inserted.

The circuit board 14 is inserted into the insertion opening 108 so as to be interposed between the contactor 20L and the contactor 20R. Thus, the contactor 20L naturally moves in the left direction in accordance with the insertion of the circuit board 14. Similarly, the contactor 20R naturally moves in the right direction in accordance with the insertion of the circuit board 14. As a result, the circuit board 14 is naturally sandwiched between the plurality of contactors 20L and the plurality of contactors 20R.

The plurality of contactors 20 sandwich the circuit board 14 to thereby come into contact with the electric circuit formed on the circuit board 14. Thus, the plurality of contactors 20 and the electric circuit of the circuit board 14 can be electrically connected to each other.

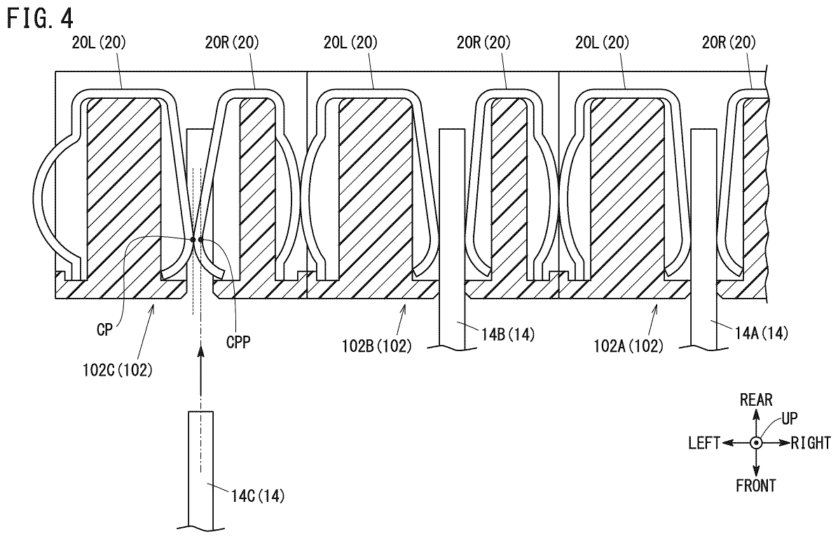

FIG. 4 is a view showing three contact blocks 102 (102A, 102B, and 102C) arranged in the left-right direction in the same cross-sectional view as that of FIG. 3A.

The plurality of I/O units 100 are arranged in the left-right direction, and thus the plurality of contact blocks 102 are arranged in the left-right direction. In this case, the plurality of contactors 20L of the right contact block 102 of the two adjacent contact blocks 102 and the plurality of contactors 20R of the left contact block 102 thereof are in contact with each other. Thus, the contactors 20L of the right contact block 102 and the contactors 20R of the left contact block 102 are electrically connected to each other.

For example, in the example of FIG. 4, the plurality of contactors 20L of the contact block 102A and the plurality of contactors 20R of the contact block 102B are in contact with each other. Thus, the plurality of contactors 20L of the contact block 102A and the plurality of contactors 20R of the contact block 102B are electrically connected to each other.

A circuit board 14A (14) is inserted into the contact block 102A. A circuit board 14B (14) different from the circuit board 14A is inserted into the contact block 102B. The circuit board 14A and the circuit board 14B are electrically connected to each other via the plurality of contactors 20L of the contact block 102A and the plurality of contactors 20R of the contact block 102B.

In the example of FIG. 4, the plurality of contactors 20L of the contact block 102B and the plurality of contactors 20R of the contact block 102C are in contact with each other. Thus, the plurality of contactors 20L of the contact block 102B and the plurality of contactors 20R of the contact block 102C are electrically connected to each other.

A circuit board 14C (14) different from the circuit board 14A and the circuit board 14B is inserted into the contact block 102C. The circuit board 14B and the circuit board 14C are electrically connected to each other via the plurality of contactors 20L of the contact block 102B and the plurality of contactors 20R of the contact block 102C. Since the circuit board 14B can be electrically connected to the circuit board 14A as described above, the circuit board 14C can also be electrically connected to the circuit board 14A via the circuit board 14B.

In the example of FIG. 4, the plurality of contactors 20R of the contact block 102C receive a leftward force from the contact block 102B. The leftward force also acts on the plurality of contactors 20L of the contact block 102C via the contact points CP between the plurality of contactors 20R and the plurality of contactors 20L of the contact block 102C. As a result, the plurality of contactors 20L of the contact block 102C are shifted to the left as a whole.

The plurality of contactors 20L of the contact block 102C shift to the left as a whole, and as a result, the positions of the contact points CP are also shifted to the left. Note that a point CPP in FIG. 4 indicates the position of the contact point CP before the contact point CP is shifted to the left.

When the circuit board 14 is inserted into the insertion opening 108 in a state where the position of the contact point CP is shifted to the left, the contactor 20 interferes with the circuit board 14 in the front-rear direction. That is, the contactor 20 hinders the circuit board 14 from being inserted. If the circuit board 14 is forcibly inserted, the contactor 20 may be subjected to buckling (damage) by the force received from the circuit board 14. Note that a similar problem occurs when the position of the contact point CP is shifted to the right.

With the above in mind, a contact block 10 according to an embodiment will be described below. However, explanations that overlap with those of the reference examples will be omitted insofar as possible in the following description. Elements that have been described in the above reference examples are denoted by the same reference numerals as in the above reference examples unless otherwise specified.

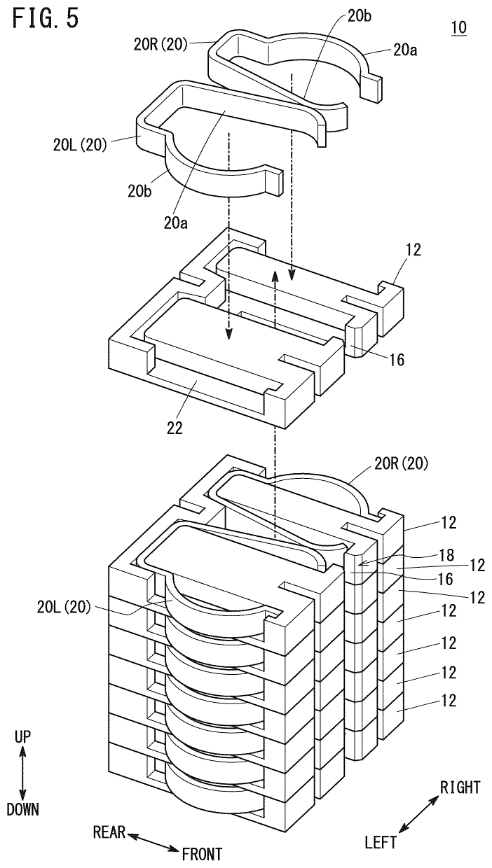

FIG. 5 is a view showing a contact block 10 according to an embodiment.

The contact block 10 includes a plurality of blocks 12. The plurality of blocks 12 are stacked along the up-down direction. The total number of the blocks 12 stacked together is not particularly limited. An operator may change the total number of the stacked blocks 12, as necessary. The size of the entire contact block 10 in the up-down direction varies depending on the total number of the blocks 12 stacked together.

Each block 12 has a slit 16. The slit 16 is formed in the front portion of each block 12. The slit 16 extends rearward from the front end of each block 12. The circuit board 14 (see the reference examples) can be inserted into the slit 16.

The plurality of slits 16 communicate with each other in the up-down direction by stacking the plurality of blocks 12 in the up-down direction. The plurality of slits 16 communicating with each other form an insertion opening 18 for the circuit board 14.

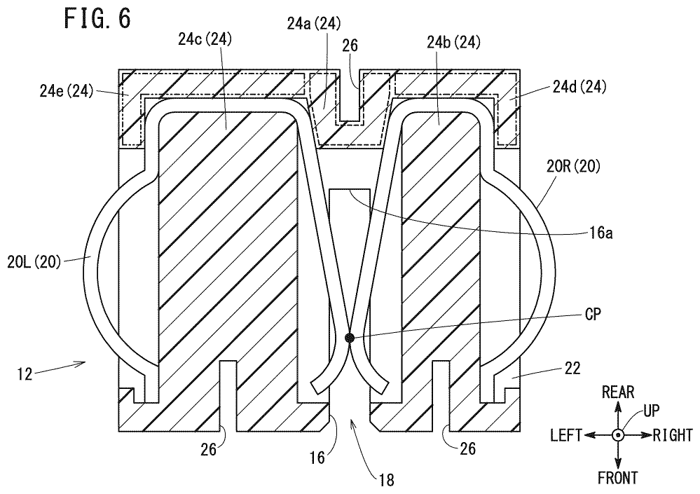

FIG. 6 is a top view of the block 12 according to the embodiment.

The block 12 includes a support member 22, a wall portion 24, and a plurality of engagement portions 26. The wall portion 24 includes a first wall portion 24a, a second wall portion 24b, a third wall portion 24c, a fourth wall portion 24d, and a fifth wall portion 24e.

The support member 22 is a member that supports the two contactors 20 from below. The support member 22 has a substantially flat plate shape. The material for the support member 22 includes, for example, an insulating resin. The slit 16 is formed by cutting out a portion of the support member 22. The rear end portion 16a of the slit 16 is positioned forward of the first wall portion 24a. However, the rear end portion 16a may reach the first wall portion 24a.

At least one of the upper portion and the lower portion of the support member 22 may be provided with a fitting structure for fitting with another block 12 that is stacked on the support member 22 in the up-down direction. The fitting structure includes, for example, a protrusion and a groove into which the protrusion is fitted. However, the illustration of the fitting structure is omitted.

Two contactors 20 are installed on each support member 22. Here, the two contactors 20 are arranged on the upper surface of the support member 22 such that a substantially U-shaped opening is opened toward the front direction when the support member 22 is viewed from above. The two contactors 20 extend rearward in the front-rear direction beyond the rear end portion 16a of the slit 16.

One contactor 20R and one contactor 20L are installed on each support member 22. The contactor 20R and the contactor 20L are arranged in the left-right direction on the upper surface of the support member 22.

The material for the wall portion 24 includes, for example, an insulating resin. The wall portion 24 may include the same material as the support member 22. The wall portion 24 and the support member 22 may be integrally formed.

The first wall portion 24a is a positional dislocation prevention wall provided on the support member 22. In the example of FIG. 6, a portion surrounded by a dashed line frame is the first wall portion 24a. That is, the first wall portion 24a is disposed rearward of the slit 16 in the front-rear direction. The first wall portion 24a is disposed between the two contactors 20 in the left-right direction.

The first wall portion 24a prevents positional dislocation of the two adjacent contactors 20 on the support member 22 in a direction in which the contactors 20 approach each other. That is, the first wall portion 24a abuts against the contactor 20L from the right. This restricts the contactor 20L from being dislocated in the rightward direction. The first wall portion 24a abuts against the contactor 20R from the left. Thus, the contactor 20R is restricted from being dislocated in the leftward direction.

The two contactors 20 are prevented from being dislocated in the direction in which the two contactors 20 approach each other, and thus the contact point CP is prevented from being displaced in the left-right direction. That is, the first wall portion 24a prevents the contact point CP from being dislocated in the left-right direction. Since the contact point CP is prevented from being dislocated in the left-right direction, the contactor 20 is less likely to interfere with the circuit board 14 in the front-rear direction. This reduces the possibility that the contactor 20 is subjected to buckling by the force received from the circuit board 14.

The first wall portion 24a can also hold the contactors 20 so as to prevent the deformation of the contactors 20 in the approaching direction. For example, the first wall portion 24a can prevent the contactor 20R from excessively expanding in the leftward direction. The first wall portion 24a can also prevent the contactor 20L from excessively expanding in the rightward direction.

The second wall portion 24b is a right positioning wall portion provided inside the substantially U-shaped contactor 20R. The second wall portion 24b positions the contactor 20R to some extent in the left-right direction. The second wall portion 24b and the first wall portion 24a sandwich the contactor 20R in the left-right direction. Thus, the contactor 20R is positioned more accurately in the left-right direction.

The third wall portion 24c is a left positioning wall portion provided inside the substantially U-shaped contactor 20L. The third wall portion 24c positions the contactor 20L to some extent in the left-right direction. The third wall portion 24c and the first wall portion 24a sandwich the contactor 20L in the left-right direction. Thus, the contactor 20L is positioned more accurately in the left-right direction.

The fourth wall portion 24d is a right auxiliary wall portion that sandwiches the contactor 20R in the front-rear direction cooperatively with the second wall portion 24b. Thus, the contactor 20R is positioned more accurately in the front-rear direction.

In the illustration of FIG. 6, a portion surrounded by a long-dashed short-dashed line frame is the fourth wall portion 24d. The fourth wall portion 24d preferably extends to the right of the contactor 20R. Thus, the contactor 20R is sandwiched between the fourth wall portion 24d and the second wall portion 24b in the left-right direction. As a result, the contactor 20R is positioned more accurately in the left-right direction.

The fourth wall portion 24d is connected to the first wall portion 24a. However, the fourth wall portion 24d and the first wall portion 24a may be separated from each other.

The fifth wall portion 24e is a left auxiliary wall portion that sandwiches the contactor 20L in the front-rear direction cooperatively with the third wall portion 24c. Thus, the contactor 20L is positioned more accurately in the front-rear direction.

In the illustration of FIG. 6, a portion surrounded by a long-dashed double-short-dashed line frame is the fifth wall portion 24e. The fifth wall portion 24e preferably extends to the left of the contactor 20L. Thus, the contactor 20L is sandwiched between the fifth wall portion 24e and the third wall portion 24c in the left-right direction. As a result, the contactor 20L is positioned more accurately in the left-right direction.

The fifth wall portion 24e is connected to the first wall portion 24a. However, the fifth wall portion 24e and the first wall portion 24a may be separated from each other.

Each of the plurality of engagement portions 26 is, for example, a slit different from the slit 16. In the support member 22, the plurality of engagement portions 26 are formed on both sides in the insertion direction of the circuit board 14. That is, in the support member 22, the plurality of engagement portions 26 are formed on both sides in the front-rear direction. In the present embodiment, the engagement portions 26 are provided at three positions, i.e., at the front portion of the second wall portion 24b, the front portion of the third wall portion 24c, and the rear portion of the first wall portion 24a. However, the number of the engagement portions 26 and the arrangement thereof in the block 12 may be changed as appropriate.

The plurality of engagement portions 26 engage with a plurality of protrusions provided on another member. Here, the other member is a member to which the block 12 is fixed. Specifically, the plurality of protrusions with which the plurality of engagement portions 26 engage are provided on, for example, the housing of the I/O unit 100. With the above configuration, owing to the plurality of engagement portions 26, for example, the block 12 can be easily fixed to the housing of the I/O unit 100.

### MODIFICATIONS

Modifications of the above-described embodiment will be described below. However, explanations that overlap with those of the embodiment will be omitted insofar as possible in the following description. Elements that have been described in the above embodiment are denoted by the same reference numerals as in the above embodiment unless otherwise specified.

### Modification 1

The contact block 10 may be composed of a single block 12.

### Modification 2

The fourth wall portion 24d may be omitted.

### Modification 3

The fifth wall portion 24e may be omitted.

### Combination of Plurality of Modifications

The plurality of modifications described above may be appropriately combined together within a range in which no technical inconsistencies occur.

### Invention Obtained from Embodiments

The inventions that can be grasped from the above-described embodiment and the modifications thereof will be described below.

### First Aspect of Invention

A first aspect of the present invention is characterized by the block (12) including: the two contactors (20) which are arranged adjacent to each other along the predetermined installation direction to be electrically connected to each other; and the support member (22) configured to support the two contactors so as to be arranged along the predetermined installation direction, wherein the support member is provided with the slit (16) configured to allow the detachable circuit board (14) to be inserted between the two contactors along the insertion direction that is orthogonal to the predetermined installation direction, in order to electrically connect the detachable circuit board and the two contactors, the two contactors have the substantially U-shape that opens toward the direction opposite to the insertion direction when viewed from the direction orthogonal to the predetermined installation direction and the insertion direction, and the first wall portion (24a) is provided on the support member, the first wall portion being configured to prevent the contact point (CP) between the two contactors from being dislocated in the predetermined installation direction.

This reduces the risk of buckling of the contactor.

The two contactors may extend in the insertion direction beyond the slit, and the first wall portion may be provided between the two contactors and located on a side of the insertion direction beyond the slit. This prevents the contact point of the contactor from being displaced in the left-right direction.

The first aspect of the invention may further include the second wall portion (24b) provided so as to sandwich one of the contactors between the second wall portion and the first wall portion in the predetermined installation direction; and the third wall portion (24c) provided so as to sandwich another of the contactors cooperatively with the first wall portion in the predetermined installation direction. This more suitably prevents the contact point of the contactor from being dislocated in the left-right direction.

In the support member, the engagement portions (26) configured to fix the support member to another member may be provided on both sides in the insertion direction. This makes it possible to suitably fix the block to another member. Here, the other member is, for example, an I/O unit.

### Second Aspect of Invention

A second aspect of the present invention is characterized by the contact block (10) into which the circuit board (14) is inserted, the contact block and another contact block being arranged adjacent to each other along the predetermined installation direction to be electrically connected to each other, the contact block including: the plurality of blocks according to the first aspect, wherein the plurality of blocks are stacked in the direction orthogonal to the predetermined installation direction and the insertion direction in a manner so that the slit of each of the plurality of blocks communicates with the slit of another of the plurality of blocks.

This reduces the risk of buckling of the contactor.

### REFERENCE SIGNS LIST

10: contact block
12: block
14: circuit board
16: slit
18: insertion opening
20 (20L, 20R): contactor
22: support member
24: wall portion
24a: first wall portion
24b: second wall portion
24c: third wall portion
26: engagement portion

1. A block comprising:
two contactors which are arranged adjacent to each other along a predetermined installation direction to be electrically connected to each other; and
a support member configured to support the two contactors so as to be arranged along the predetermined installation direction,
wherein the support member is provided with a slit configured to allow a detachable circuit board to be inserted between the two contactors along an insertion direction that is orthogonal to the predetermined installation direction, in order to electrically connect the detachable circuit board and the two contactors,
the two contactors have a substantially U-shape that opens toward a direction opposite to the insertion direction when viewed from a direction orthogonal to the predetermined installation direction and the insertion direction, and
a first wall portion is provided on the support member, the first wall portion being configured to prevent a contact point between the two contactors from being dislocated in the predetermined installation direction.

2. The block according to claim 1, wherein
the two contactors extend in the insertion direction beyond the slit, and
the first wall portion is provided between the two contactors and located on a side of the insertion direction beyond the slit.

3. The block according to claim 2, further comprising:
a second wall portion provided so as to sandwich one of the contactors between the second wall portion and the first wall portion in the predetermined installation direction; and
a third wall portion provided so as to sandwich another of the contactors cooperatively with the first wall portion in the predetermined installation direction.

4. The block according to claim 1, wherein
in the support member, engagement portions configured to fix the support member to another member are provided on both sides in the insertion direction.

5. A contact block into which a circuit board is inserted, the contact block and another contact block being arranged adjacent to each other along a predetermined installation direction to be electrically connected to each other, the contact block comprising:
a plurality of the blocks according to claim 1, wherein the plurality of blocks are stacked in a direction orthogonal to the predetermined installation direction and the insertion direction in a manner so that the slit of each of the plurality of blocks communicates with the slit of another of the plurality of blocks.
